(19) United States
(12) Patent Application Publication
(10) Pub. No.: US 2026/0320033 A1
(43) Pub. Date: Oct. 15, 2026

(54) USER KNOWLEDGE AND DATA GROUNDING FOR PROACTIVE PERSONALIZED ACTION RECOMMENDATIONS

(71) Applicant: Samsung Electronics Co., Ltd., Suwon-si (KR)

(72) Inventors: Anil Sunder Yadav, San Jose, CA (US); Melvin Lobo, Fremont, CA (US); Divya Neelagiri, Dublin, CA (US); Preeti Saraswat, Santa Clara, CA (US)

(21) Appl. No.: 19/390,161

(22) Filed: Nov. 14, 2025

Related U.S. Application Data
(60) Provisional application No. 63/789,010, filed on Apr. 15, 2025.

(51) Int. Cl. G06F 16/242; G06F 16/2457; G06F 16/248

(52) U.S. Cl. CPC G06F 16/242; G06F 16/24578; G06F 16/248

(57) ABSTRACT

A method includes obtaining data inputs and context information. The method also includes proactively generating multiple actions based on the data inputs and the context information using one or more machine learning models. The method further includes obtaining reference data relevant to the context information. The method also includes verifying the multiple actions using the reference data. The method further includes identifying one or more selectable actions from the multiple actions. The method also includes generating one or more actionable task recommendations based on the one or more selectable actions. In addition, the method includes initiating presentation of the one or more actionable task recommendations on a display.

### CROSS-REFERENCE TO RELATED APPLICATION AND CLAIM OF PRIORITY

This application claims priority under 35 U.S.C. § 119(e) to U.S. Provisional Patent Application No. 63/789,010 filed on Apr. 15, 2025, which is hereby incorporated by reference in its entirety.

### TECHNICAL FIELD

This disclosure relates generally to contextual assistance in digital electronic devices. More specifically, this disclosure relates to user knowledge and data grounding for proactive personalized action recommendations.

### BACKGROUND

A user knowledge graph (UKG) is a representation of user interests, preferences, behaviors, and interactions within a system. A UKG captures information about user characteristics, such as demographics, past interactions, preferences, and inferred interests, which can be used to create a personalized profile for the user. By leveraging a UKG, personalized actions may be provided based on a user profile to enhance user experiences and increase user engagement.

### SUMMARY

This disclosure relates to user knowledge and data grounding for proactive personalized action recommendations.

In a first embodiment, a method includes obtaining, by at least one processing device of an electronic device, data inputs and context information. The method also includes proactively generating, by the at least one processing device, multiple actions based on the data inputs and the context information using one or more machine learning models. The method further includes obtaining, by the at least one processing device, reference data relevant to the context information. The method also includes verifying, by the at least one processing device, the multiple actions using the reference data. The method further includes identifying, by the at least one processing device, one or more selectable actions from the multiple actions. The method also includes generating, by the at least one processing device, one or more actionable task recommendations based on the one or more selectable actions. In addition, the method includes initiating, by the at least one processing device, presentation of the one or more actionable task recommendations on a display.

In a second embodiment, an electronic device includes at least one processing device configured to obtain data inputs and context information. The at least one processing device is also configured to proactively generate multiple actions based on the data inputs and the context information using one or more machine learning models and obtain reference data relevant to the context information. The at least one processing device is further configured to verify the multiple actions using the reference data. The at least one processing device is also configured to identify one or more selectable actions from the multiple actions. The at least one processing device is further configured to generate one or more actionable task recommendations based on the one or more selectable actions. In addition, the at least one processing device is configured to initiate presentation of the one or more actionable task recommendations on a display.

In a third embodiment, a non-transitory machine-readable medium contains instructions that when executed cause at least one processor of an electronic device to proactively generate multiple actions based on data inputs and context information using one or more machine learning models. The non-transitory machine-readable medium also contains instructions that when executed cause the at least one processor to verify the multiple actions using reference data relevant to the context information and identify one or more selectable actions from the multiple actions. The non-transitory machine-readable medium further contains instructions that when executed cause the at least one processor to generate one or more actionable task recommendations based on the one or more selectable actions. In addition, the non-transitory machine-readable medium contains instructions that when executed cause the at least one processor to initiate presentation of the one or more actionable task recommendations on a display.

Any single one or any combination of the following features may be used with the first, second, or third embodiment. The reference data may be obtained by collecting, using a learning engine, user knowledge data from at least one of user profile data, a user knowledge graph, a user knowledge summary, user activities, app data, or data reasoning prompts. The reference data may be created based on the user knowledge data and a data grounding service. The data grounding service may be configured to correlate textual or unstructured data with entities and relationships represented in the user knowledge graph. The data inputs and the context information may be formatted into key-value pairs, and the key-value pairs may be provided to the one or more machine learning models. The multiple actions may be generated using a scenario-based dynamic path generation process to identify feasible actions by a user after an event based on current context, historical data, and previous interactions stored in a user knowledge database. The one or more selectable actions may be identified by assigning a likelihood score to each of the multiple actions based on the data inputs and the context information and identifying which of the multiple actions has a likelihood score exceeding a specified threshold based on user preferences stored in a user knowledge database. To identify the one or more selectable actions, action paths of the multiple actions may be identified based on device functionality, and executable function calls for the action paths may be generated. To generate the one or more actionable task recommendations, a ranker model may be used to prioritize the action paths based on at least one of: one or more past user interactions, context relevancy, or one or more user preferences determined from a user knowledge database.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example architecture for user knowledge and data grounding for proactive personalized action recommendations according to this disclosure;

FIG. 3 illustrates an example dynamic user knowledge graph for user knowledge and data grounding for proactive personalized action recommendations according to this disclosure;

FIG. 4 illustrates an example graphical user interface for user knowledge and data grounding for proactive personalized action recommendations according to this disclosure;

FIG. 5 illustrates another example architecture for user knowledge and data grounding for proactive personalized action recommendations according to this disclosure; and

FIG. 6 illustrates an example method for user knowledge and data grounding for proactive personalized action recommendations according to this disclosure.

### DETAILED DESCRIPTION

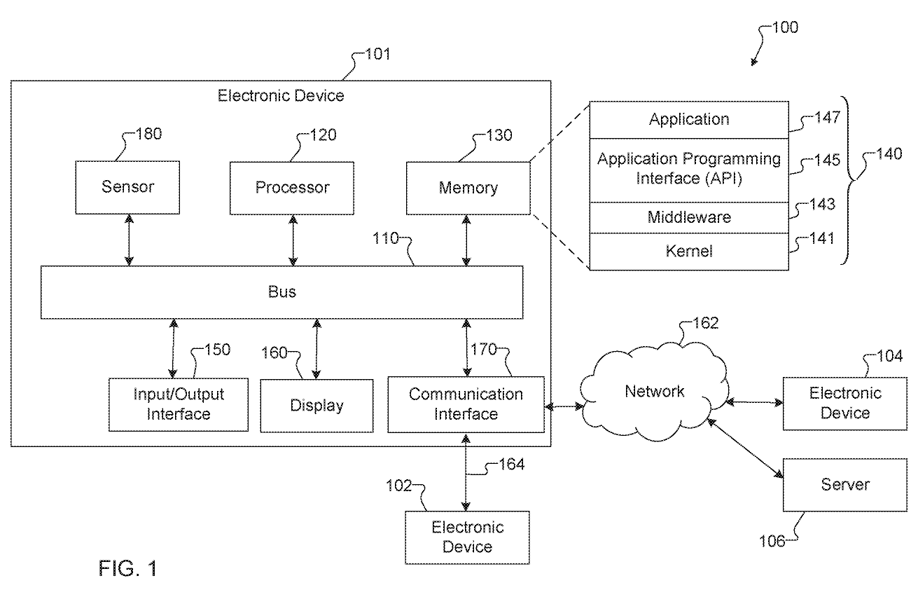

FIGS. 1-6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As noted above, a user knowledge graph (UKG) is a representation of user interests, preferences, behaviors, and interactions within a system. A UKG captures information about user characteristics, such as demographics, past interactions, preferences, and inferred interests, which can be used to create a personalized profile for the user. By leveraging a UKG, personalized actions may be provided based on a user profile to enhance user experiences and increase user engagement.

Unfortunately, attempting to provide personalized actions from a knowledge graph faces several challenges. For example, user knowledge may come from diverse sources, leading to semantic heterogeneity in the data. Also, a user may have limited interactions within a system, resulting in sparse data for building a UKG. Thus, for instance, when dealing with new users, insufficient data is available to generate meaningful personalized actions. Further, user preferences and interests may change over time, requiring the UKG to be continuously adapted to reflect the latest behaviors of the user. Moreover, user knowledge may also be context-dependent with preferences and interests varying based on the current situation, environment, or task. In addition, while personalized actions generated from the UKG should be accurate and relevant to the user, simply suggesting actions based on past behaviors may not suffice. To ensure a positive user experience, it may be useful or important to introduce new and diverse content, offering novel actions rather than just predictable ones.

This disclosure provides techniques for user knowledge and data grounding for proactive personalized action recommendations. As described in more detail below, data inputs and context information can be obtained, and multiple actions can be generated based on the data inputs and the context information using one or more machine learning models (such as one or more large language models). Reference data relevant to the context information can be obtained and used to verify the multiple actions. One or more selectable actions can be identified from the multiple actions, and one or more actionable task recommendations can be generated based on the one or more selectable actions. The one or more actionable task recommendations can be presented to a user on a display.

In this way, the described techniques can be used to provide proactive contextual assistance for users of electronic devices in different environments while being intuitive, easy to use, and secure. For example, large language models (LLMs) and other machine learning models have the potential to address challenges in representing user knowledge in UKGs since machine learning models can understand different representations and bridge semantic heterogeneity by providing a unified representation of UKGs. As such, machine learning models may alleviate data sparsity issues by generating relevant content and recommendations based on limited user interactions and profile data. Further, machine learning models may learn and adapt to changing preferences and recommend personalized actions more accurately. Machine learning models can understand context from textual data, allowing them to generate personalized responses and actions.

The terms “proactive” and “proactively” in this disclosure mean one or more actions taken without an express user request. For example, the described techniques provide contextual assistance without an express user input or an express user request to generate the contextual assistance. Although techniques in this disclosure may request user input in response to generated actions, the techniques in this disclosure do not necessarily require a user request to generate the aforementioned contextual assistance actions.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to user knowledge and data grounding for proactive personalized action recommendations.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to user knowledge and data grounding for proactive personalized action recommendations. These functions can be performed by a single application or by multiple applications that each conduct one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high-definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network. The electronic device 101 can also be an augmented reality wearable device, such as eyeglasses, which include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to user knowledge and data grounding for proactive personalized action recommendations.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

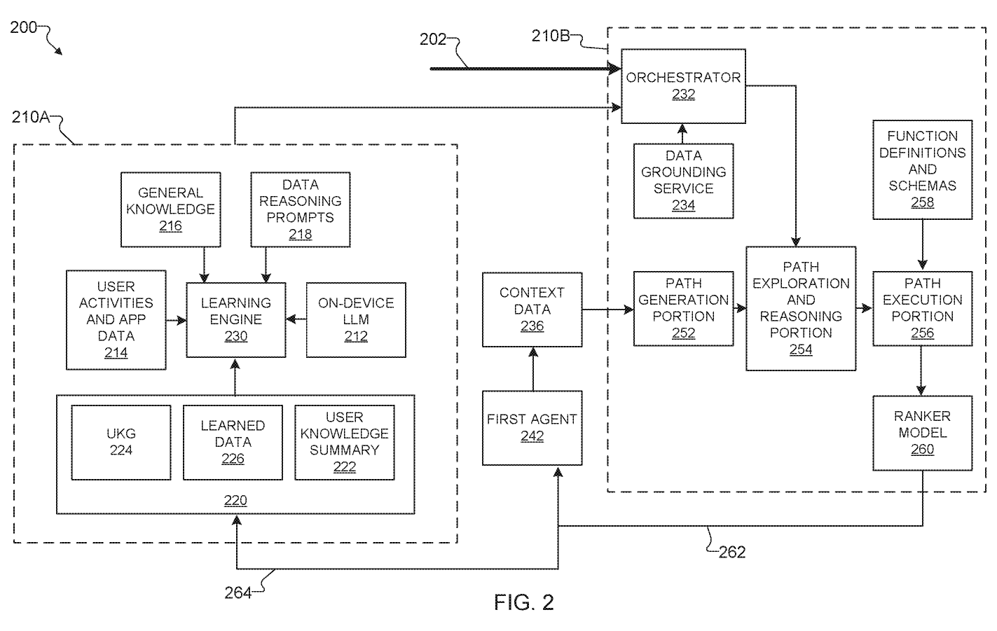

FIG. 2 illustrates an example architecture 200 for user knowledge and data grounding for proactive personalized action recommendations according to this disclosure. For ease of explanation, the architecture 200 is described as involving the use of the electronic device 101 in the network configuration 100 of FIG. 1. However, the architecture 200 may be used with any other suitable device (such as the server 106) or a combination of devices (such as the electronic device 101 and the server 106) and in any other suitable system(s).

As shown in FIG. 2, the architecture 200 includes a learning and knowledge building portion 210A configured to receive data inputs 202, such as personally identifiable information (PII) reference data and application data. The learning and knowledge building portion 210A includes a user knowledge database 220 coupled to a learning engine recommendation generation function 210B.

The user knowledge database 220 includes a user knowledge summary 222, one or more UKGs 224, and learned data 226. The user knowledge summary 222 can include a distilled textual or tabular overview of characteristics of one or more users and may be generated based on the one or more UKGs 224. The one or more UKGs 224 are graphical representations of characteristics of the user(s) and may be updated based on user interactions with the architecture 200, such as based on user interactions with other applications that are in communication with the architecture 200. The learned data 226 includes iterations of selected actions by the user derived from previous user interactions with the architecture 200. For example, the learned data 226 may include action paths, applications used by the action paths, context information associated with the selected action path, data inputs (such as from applications running on the electronic device 101) associated with the selected action path, generated reference data associated with the selected action path, or a combination thereof.

The learning engine recommendation generation function 210B is coupled to at least one on-device LLM 212 and can be configured to receive user activities and app data 214, general knowledge 216, and data reasoning prompts 218. The general knowledge 216 could be received from applications stored on-device. The data reasoning prompts 218 may represent predefined reasoning prompts loaded on-device to guide the on-device LLM 212 in generating desired outputs. The on-device LLM 212 may use the data reasoning prompts 218 and the general knowledge 216 to provide a learning engine 230 with inputs used to generate a user knowledge summary 222 as discussed below.

The learning and knowledge building portion 210A can be communicatively coupled to a learning engine recommendation generation function 210B by an orchestrator 232. For example, the learning engine recommendation generation function 210B may provide output to the orchestrator 232. The orchestrator 232 can be communicatively coupled to a data grounding service 234 and can be configured to provide reference data 236 to a multi-agent generation architecture 240. In some cases, the data inputs 202 and context information may be formatted into key-value pairs by the orchestrator 232, such as by using a key-value table where a unique key is associated with a specific value. Once formatted as key-value pairs, the data inputs 202 and the context information key-value pairs can be provided to one or more machine learning models, such as one or more LLMs, of the multi-agent generation architecture 240. In some cases, the key-value pairs may be stored in a cache, such as a key-value cache in the user knowledge database 220 or other database, allowing the one or more machine learning models of the multi-agent generation architecture 240 to reuse previously-computed representations instead of recalculating representations for every new token. The key-value pair structure of the data inputs 202 and the context information thus allows the one or more machine learning models to provide efficient memory management and accelerated inference during text generation.

The multi-agent generation architecture 240 includes a first agent 242, a second agent 244, and a third agent 246. The first agent 242 provides input, including current context information 238, to a path generation portion 252 of the learning engine recommendation generation function 210B. The path generation portion 252 generates multiple actions using one or more machine learning models, such as by using a scenario-based dynamic path generation process. This allows the path generation portion 252 to identify feasible actions by a user after an event based on the current context information 238, historical data, and previous interactions stored in a user knowledge database 220. The path generation portion 252 outputs the multiple actions to a path exploration and reasoning portion 254.

The path exploration and reasoning portion 254 explores the multiple actions, including action paths, to determine one or more selectable actions. The one or more selectable actions can be identified, for example, by assigning a likelihood score to each of the multiple actions based on the data inputs 202 and the context information 238 and identifying which of the multiple actions has a likelihood score exceeding a specified threshold, which could be based on one or more user preferences stored in the user knowledge database 220. The path exploration and reasoning portion 254 may also identify action paths of the multiple actions based on device functionality and generate executable function calls for the action paths. The path exploration and reasoning portion 254 outputs the one or more selectable actions to a path execution portion 256.

The path execution portion 256 receives information from predefined definitions and schemas 258 and provides the one or more selectable actions to a ranker model 260. The ranker model 260 generates one or more actionable task recommendations based on the one or more selectable actions and provides a final user recommendation 262 to a user, such as by displaying the final user recommendation 262 on a display (like the display 160). For example, the ranker model 260 may prioritize the action paths based on at least one of one or more past user interactions, context relevancy, or one or more user preferences determined from a user knowledge database The final user recommendation 262 may also be provided to the first agent 242 and may be used, based on user selections, as part of a user feedback integration 264, which can store user-selected actions in the user knowledge database 220 (such as part of the learned data 226). This allows for updating of the learning engine recommendation generation function 210B.

On-device, the architecture 200 allows for the learning engine 230 to use user activity data, device data, location data, and/or application data to create a user knowledge summary 222 and a user knowledge graph (UKG) 224. For example, the user knowledge summary 222 can be generated from the UKG 224, such as by synthesizing the information captured in the UKG 224 to provide a concise overview of the user characteristics, preferences, behavior, and interactions within a system. The user knowledge summary 222 can be used in various ways, such as remotely on a server 106 to generate a final recommendation. For instance, the server 106 could include the multi-agent generation architecture 240 to process data synchronously to generate recommendations, thereby leveraging machine learning, generative AI, and data analytics.

During operation, the architecture 200 may be triggered by an event, such as when a user initiates an application. Thus, in some embodiments, the user does not have to explicitly provide a command. Rather, the architecture 200 can proactively understand future possible actions and proactively suggest, to the user, one or more actions that may be executed at the discretion of the user. In some embodiments, when an event occurs, an app context (such as screen data) can be sent to the architecture 200 in real-time, and this event may be referred to as a context-triggered event.

The architecture 200 may implement multi-agent processing, such as in the form of sequential LLM-based agents. For example, the first agent 242 can execute the path generation portion 252 and assume the role of the user. The first agent 242 can analyze the provided screen data or other data, simulate possible actions that users can take, and generate possible proactive actions based on past user preferences and current information. For path exploration and reasoning portion 254, the second agent 244 can evaluate each possible action and determine the validity of each path, such as based on PII, reference data from the device, and the user knowledge summary 222 built on-device.

The data grounding service 234 provides an interface to the learned data 226. Data grounding involves the process of associating textual or unstructured data with entities and relationships represented in a UKG 224. This enables interpretation and understanding of the textual or unstructured data in the context of structure knowledge captured in the UKG 224. In some cases, the data grounding service 234 can be achieved by (i) entity recognition and linking, such as by creating structured knowledge based on textual or unstructured data; (ii) relation extraction, such as by extracting user interactions and semantic relations based on textual or unstructured data; (iii) textual entailment and inference, such as by determining whether information conveyed in the data entails or contradicts the knowledge graph; (iv) reasoning, such as by leveraging the grounded data to perform reasoning tasks over the UKG 224; and/or (v) contextual grounding, such as by considering the contextual information surrounding the data to disambiguate.

In some cases, the data grounding service 234 could use the data inputs 202 from other applications or systems of the electronic device 101 to prevent hallucinations. For example, a user personal data sync service (PDSS) may be used to retrieve contact databases from user devices, application names from user devices, and smart home Internet of Things (IOT) devices connected to user devices. Additionally, a media knowledge graph (KG) of each UKG 224 may be used to retrieve frequently played songs, albums, and artists and frequently watched videos. A device KG of each UKG 224 may be used to retrieve frequently used applications, battery consumption of the apps, connected devices in a user’s home, and capabilities of the device. Further, the UKG 224 may be used to retrieve user demographics, user family information, user preferences, user activity, and user behavioral patterns.

The orchestrator 232 retrieves the data inputs 202 through data retrieval functions and queries one or more LLMs, such as the on-device LLM 212, to generate recommendations and actions. For path execution portion 256, the third agent 246 processes the final valid paths. For example, the third agent 246 can select the top N paths, where N is the number of suggestions displayed to the user. For each selected path, the third agent 246 may generate executable function code that aligns with predefined system schemas derived from the predefined definitions and schemas 258.

The architecture 200 generates proactive action suggestions using the ranker model 260. For example, the ranker model 260 may be applied to prioritize and reorder the top k paths based on (i) past user interactions, including frequency and recency of similar actions from user feedback, (ii) context relevance, including how well the action fits the current app and screen data based on current context, and/or (iii) user preferences from the user knowledge database 220, such as historical cross-app preferences from learning engine 230. The final ranked suggestions are proactively displayed to the user for selection and (if selected) execution. Actions selected by the user can be logged again in the learning and knowledge building portion 210A to refine and further personalize future recommendations.

Although FIG. 2 illustrates one example of an architecture 200 for user knowledge and data grounding for proactive personalized action recommendations, various changes may be made to FIG. 2. For example, various components and functions in FIG. 2 may be combined, further subdivided, replicated, omitted, or rearranged according to particular needs. Also, one or more additional components and functions may be included if needed or desired. Further, while only three agents are described above, the multi-agent generation architecture 240 may include more or fewer agents to perform individual or groups of tasks using one or more machine learning models. In addition, although described as LLMs, the one or more machine learning models may include other or additional types of machine learning models, such as autoencoders, convolutional neural networks (CNNs), recurrent neural networks (RNNs), video language models (VLMs), and/or other suitable models to classify and generate action paths.

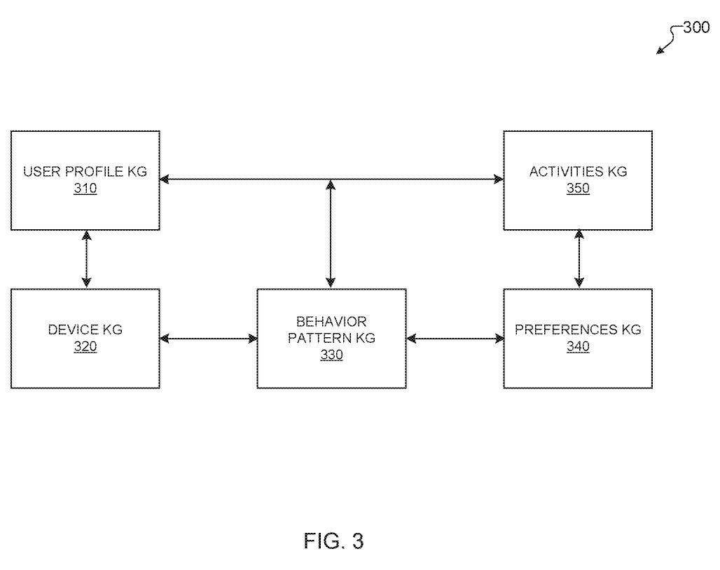

FIG. 3 illustrates an example dynamic user knowledge graph 300 for user knowledge and data grounding for proactive personalized action recommendations according to this disclosure. For ease of explanation, the dynamic user knowledge graph 300 is described as being used by the electronic device 101 in the network configuration 100 of FIG. 1. However, the dynamic user knowledge graph 300 may be used with any other suitable device (such as the server 106) or a combination of devices (such as the electronic device 101 and the server 106) and in any other suitable system(s). In some cases, the dynamic user knowledge graph 300 may be used as a UKG 224 in the architecture 200 of FIG. 2.

As shown in FIG. 3, the dynamic user knowledge graph 300 includes separate knowledge graphs focused on particular characteristics of a user and may be interconnected to each other. For example, the dynamic user knowledge graph 300 includes a user profile knowledge graph 310, a user device knowledge graph 320, a behavior pattern knowledge graph 330, a preferences knowledge graph 340, and a user activities knowledge graph 350. Each of the knowledge graphs that are part of the dynamic user knowledge graph 300 may be updated individually based on user interactions with the architecture 200, data received from applications coupled to the architecture 200, or a combination thereof. Additionally, updates or changes to one of the knowledge graphs may subsequently provide updates to one or more of the other knowledge graphs of the dynamic user knowledge graph 300.

The user knowledge summary 222 may include information from each portion of the dynamic user knowledge graph 300. For example, the user knowledge summary 222 may include information from (i) the user profile knowledge graph 310, including demographic details (such as age, gender, and location, and family information); (ii) the user device knowledge graph 320, including devices used by the user as well as location and placement of the devices and user interaction history with the system; (iii) the preferences knowledge graph 340, such as favorite topics, genres, products, content categories, and any other identified preferences; (iv) the user activities knowledge graph 350, including browsing habits, consumption patterns, engagement levels, frequency of interactions; and (v) the behavior pattern knowledge graph 330, including user usage, sleep, health patterns. The dynamic user knowledge graph 300 may also be used to infer characteristics, such as predicted preferences and behaviors.

Although FIG. 3 illustrates one example of a dynamic user knowledge graph 300 for user knowledge and data grounding for proactive personalized action recommendations, various changes may be made to FIG. 3. For example, other knowledge graphs, such as knowledge graphs based on user media preferences or user language preferences, may be used.

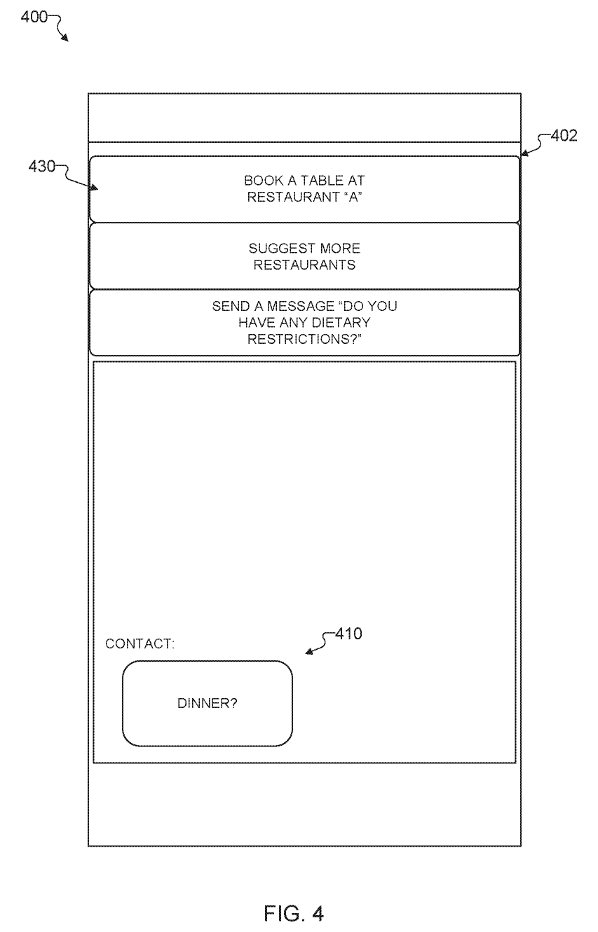

FIG. 4 illustrates an example graphical user interface 400 for user knowledge and data grounding for proactive personalized action recommendations according to this disclosure. For ease of explanation, the graphical user interface 400 is described as being used with the architecture 200 of FIG. 2 and the electronic device 101 in the network configuration 100 of FIG. 1. However, the graphical user interface 400 may be used with any other suitable device (such as the server 106) or a combination of devices (such as the electronic device 101 and the server 106) and in any other suitable system(s).

As shown in FIG. 4, the graphical user interface 400 may be shown to a user on a display 402 (which could represent the display 160). The electronic device 101 may be running an application on the display 402, such as a messaging service between the user and a contact. The graphical user interface 400 allows the user to select at least one of one or more actionable task recommendations 430. In some cases, the graphical user interface 400 may be provided within or on top of an application running on the electronic device 101. For example, the architecture 200 may be used as an intelligent dinner reservation assistant, allowing an enhanced decision flow for the user. In such situations, the architecture 200 may evaluate the intent of the user and context information 410. In this scenario, the user wants to make a dinner reservation with a contact.

Before retrieving specific data, the architecture 200 can simulate possible paths the user might take based on available context, such as the context information 410, using the path generation portion 252. For example, for a first action path, the architecture 200 may check a schedule of the user before proceeding with reservation planning. To do so, the architecture 200 may retrieve user preferences and schedule (such as from the UKG 224 and the user activities and application data 214) and ensure the user is free at the intended time. If the schedule is clear, the architecture 200 can proceed with dinner planning by, for example, finding a restaurant and suggest booking using the learning engine 230.

For a second action path, the architecture 200 may offer supplemental restaurant suggestions with a search based on user preferences (such as from the UKG 224). For a third action path, the architecture 200 may send a message to ask the contact if they have any dietary restrictions or cuisine preferences, and the architecture 200 may adjust suggestions accordingly if needed. For a fourth action path, the architecture 200 may explore additional activities. For example, the architecture 200 may inquire if the user would like to do something before or after dinner, such as visit a coffee shop, visit a dessert shop, or take a short walk, in which case the architecture 200 may suggest relevant options nearby. Once these paths are evaluated, the architecture 200 selects the most efficient course of action based on real-time data.

The architecture 200 can gather key information in the path exploration and reasoning portion 254. For example, the architecture 200 may gather cuisine preferences and an approximate dinner time for the user from the user knowledge database 220. The architecture 200 may also get the user schedule from the personal information layer (PIL) data, to check for potential conflicts (such as by querying the PIL reference data) and determining an expected available time after a conflict is detected. For example, if the user is scheduled to have an appointment, the architecture 200 determines an expected available time based on an identified average duration of the appointment. The architecture 200 may also use real-time location tracking based on user location information.

The architecture 200 can also perform path exploration and decision-making for each identified path. For example, for the first action path, the architecture 200 may search for restaurants based on the cuisine preferences and location data to determine restaurants near the current location of the user. The restaurants may be ranked based on proximity to the user (factoring in time available after a potential conflict), popularity and reviews, and suitability for dinner at the preferred dinner time of the user. The architecture 200 can generate a primary recommendation based on ranking. For the second action path, the architecture 200 can generate alternative restaurant options based on user input. For example, if the user wants additional choices, the architecture 200 may suggest N additional recommendations (such as two additional recommendations) based on the previously-determined ranking. For the third action path, the architecture 200 may send a message, such as to ask the contact if they have any dietary restrictions or cuisine preferences, and the architecture 200 may monitor for a response from the contact and adjust suggestions accordingly.

The architecture 200 can present the user with one or more actionable task recommendations 430 on the graphical user interface 400. For example, the one or more actionable task recommendations 430 may include (i) booking a table at a restaurant, (ii) asking for other restaurant recommendations based on user preferences, and (iii) sending a message to a contact along with proposed text for the message. The one or more actionable task recommendations 430 can be based on the identified paths and may vary depending on context and user preferences. The one or more actionable task recommendations 430 may include any suitable number of recommendations, such as based on context and user preferences. The user may select one or more of the actionable task recommendations 430, and the architecture 200 can initiate the associated application(s) to execute the selected actionable task recommendation(s) 430. In some cases, the selected actionable task recommendation(s) 430 can be input into the user knowledge database 220 for a learning update.

Although FIG. 4 illustrates one example of a graphical user interface 400 for user knowledge and data grounding for proactive personalized action recommendations, various changes may be made to FIG. 4. For example, while only three actionable task recommendations are shown, more or fewer actionable task recommendations may be displayed. Additionally, the one or more actionable task recommendations may be displayed sequentially rather than simultaneously, where the user has the option to reject an actionable task recommendation before a subsequent actionable task recommendation is displayed.

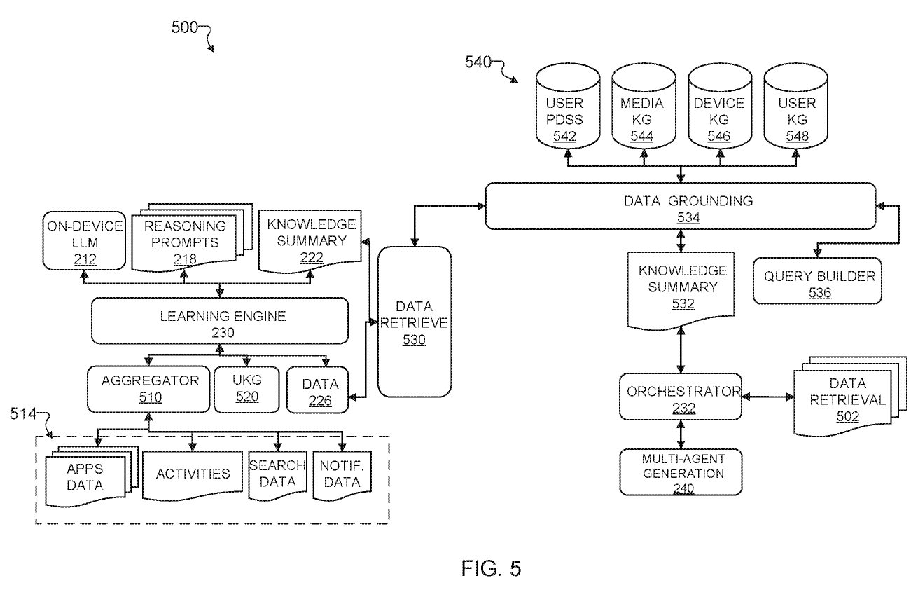

FIG. 5 illustrates another example architecture 500 for user knowledge and data grounding for proactive personalized action recommendations according to this disclosure. In this example, the architecture 500 is configured similarly to the architecture 200 of FIG. 2 except as otherwise described.

As shown in FIG. 5, the architecture 500 includes a data aggregator 510 to aggregate user activity and app data 514, such as app data, user activities, search data, and notification data. The data aggregator 510 provides the user activity and app data 514 to the learning engine 230, which also receives previously-stored UKGs 520 to provide the user knowledge summary 222 to a data retriever 530. The data retriever 530 also retrieves the learned data 226 and provides both the user knowledge summary 222 and the learned data 226 to a data grounding service 534. The data grounding service 534 generates a subsequent user knowledge summary, such as a grounded user knowledge summary that is based on knowledge graphs 540, including a user PDSS 542, a media KG 544, a device KG 546, and a user profile KG 548. In some cases, the data grounding service 534 could use data query builders 536 to retrieve the relevant data and provide to the orchestrator 232.

The architecture 500 generates a user knowledge summary 532 from user information by synthesizing the information captured in knowledge graphs, such as the user PDSS 542, the media KG 544, the device KG 546, and the user profile KG 548, to provide a concise overview of user characteristics, preferences, behavior, and interactions within a system. The user knowledge summary 532 may include, for example, (i) a user profile having demographic details, such as age, gender, and location, and family information; (ii) user environment, such as user devices and their location and placement; (iii) communication information, such as user interaction history with the system including applications used with the system; (iv) preferences, such as favorite topics, genres, products, content categories, and any other identifiable preferences; (v) activities, such as browsing habits, consumption patterns, engagement levels, and frequency of interactions; (vi) behavioral patterns, such as user usage, sleep, and health patterns; (vii) inferred characteristics, including predicted preferences and behaviors; and (viii) other relevant information.

A data grounding service 534 involves the process of associating textual or unstructured data with entities and relationships represented in the knowledge graphs 540. This enables interpretation and understanding of the textual or unstructured data in the context of structure knowledge captured in the knowledge graphs 540. The data grounding service 534 can be achieved by entity recognition and linking, relationship extraction, textual entailment and inference, leveraging the grounded textual data to perform reasoning tasks over knowledge graphs 540, contextual grounding, or a combination thereof.

Although FIG. 5 illustrates another example of an architecture 500 for user knowledge and data grounding for proactive personalized action recommendations, various changes may be made to FIG. 5. For example, various components and functions in FIG. 5 may be combined, further subdivided, replicated, omitted, or rearranged according to particular needs. Also, one or more additional components and functions may be included if needed or desired.

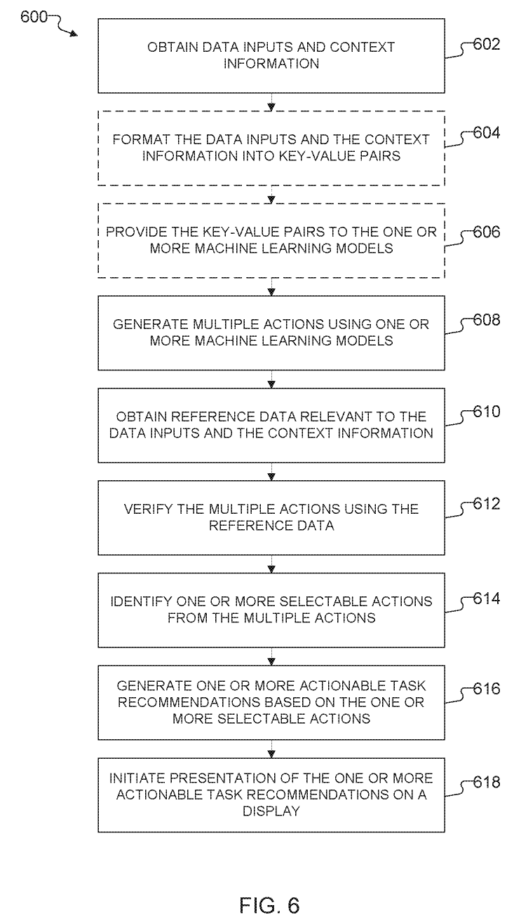

FIG. 6 illustrates an example method 600 for user knowledge and data grounding for proactive personalized action recommendations according to this disclosure. For ease of explanation, the method 600 is described as involving the use of the electronic device 101 of FIG. 1 supporting the architecture 200 of FIG. 2 or the architecture 500 of FIG. 5. However, the method 600 may be used with any other suitable proactive personalized action system architecture, and the method 600 may be used with any other suitable device (such as the server 106) or a combination of devices (such as the electronic device 101 and the server 106) and in any other suitable system(s).

As shown in FIG. 6, data inputs and context information are obtained at step 602. For example, the architecture 200 may receive data inputs 202 and context information, such as current context information 238, from one or more applications running on an electronic device 101. The architecture 200 may also obtain reference data 236, such as by collecting user knowledge data from at least one of user profile data (such as profile data stored in the learned data 226), the UKG 224, the user knowledge summary 222, user activities and app data 214, or data reasoning prompts 218 using the learning engine 230. The orchestrator 232 may create the reference data 236 based on the user knowledge data and the data grounding service 234. The data grounding service 234 may be configured to correlate textual or unstructured data with entities and relationships represented in the UKG 224.

Optionally, the data inputs and the context information may be formatted into key-value pairs at step 604. For example, the data inputs 202 and the context information 238 may be formatted into key-value pairs by the orchestrator 232 by using a key-value table. The key-value pairs or other form of the data inputs and the context information may be provided to one or more machine learning models at step 606. For example, the key-value pairs or other form of the data inputs and the context information may be provided to one or more machine learning models in the path exploration and reasoning portion 254.

Multiple actions are proactively generated using the one or more machine learning models at step 608. For example, the first agent 242 may provide inputs, including current context information 238, to the path generation portion 252. The path generation portion 252 can use one or more machine learning models to generate the multiple actions, such as by using a scenario-based dynamic path generation process to identify feasible actions by a user after an event. This could be based on current context information 238, historical data, and previous interactions stored in a user knowledge database 220.

Reference data relevant to the data inputs and the context information is obtained at step 610. For example, the orchestrator 232 may provide the reference data 236 to the path exploration and reasoning portion 254. The multiple actions are verified using the reference data at step 612. For example, the path exploration and reasoning portion 254 may use the reference data 236 to explore the multiple actions to determine one or more selectable actions. One or more selectable actions are identified from the multiple actions at step 614. For example, the path exploration and reasoning portion 254 may assign a likelihood score to each of the multiple actions based on the data inputs 202 and the context information 238 and identify which of the multiple actions has a likelihood score exceeding a specified threshold, such as based on user preferences stored in the user knowledge database 220. The path exploration and reasoning portion 254 may also identify action paths of the multiple actions based on device functionality and generate executable function calls for the action paths.

One or more actionable task recommendations are generated based on the one or more selectable actions at step 616. For example, the path execution portion 256 may receive information from predefined definitions and schemas 258 and provide the one or more selectable actions to a ranker model 260. The ranker model 260 may generate one or more actionable task recommendations based on the one or more selectable actions. The ranker model 260 may prioritize the action paths based on at least one of: one or more past user interactions, context relevancy, or one or more user preferences determined from a user knowledge database 220.

The one or more actionable task recommendations are presented on a display at step 618. For example, the ranker model 206 may output the one or more actionable task recommendations 430 on a graphical user interface 400. The one or more selected actionable task recommendations 430 may be executed and may be provided to the user knowledge database 220 as user feedback integration 264, such as part of the learned data 226.

Although FIG. 6 illustrates one example of a method 600 for user knowledge and data grounding for proactive personalized action recommendations, various changes may be made to FIG. 6. For example, while shown as a series of steps, various steps in FIG. 6 may overlap, occur in parallel, occur in a different order, or occur any number of times (including zero times).

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
obtaining, by at least one processing device of an electronic device, data inputs and context information;
proactively generating, by the at least one processing device, multiple actions using one or more machine learning models;
obtaining, by the at least one processing device, reference data relevant to the data inputs and the context information;
verifying, by the at least one processing device, the multiple actions using the reference data;
identifying, by the at least one processing device, one or more selectable actions from the multiple actions;
generating, by the at least one processing device, one or more actionable task recommendations based on the one or more selectable actions; and
initiating, by the at least one processing device, presentation of the one or more actionable task recommendations on a display.

2. The method of claim 1, wherein obtaining the reference data comprises:
collecting, using a learning engine, user knowledge data from at least one of: user profile data, a user knowledge graph, a user knowledge summary, user activities, app data, or data reasoning prompts; and
creating the reference data based on the user knowledge data and a data grounding service.

3. The method of claim 2, wherein the data grounding service is configured to correlate textual or unstructured data with entities and relationships represented in the user knowledge graph.

4. The method of claim 1, further comprising:
formatting the data inputs and the context information into key-value pairs; and
providing the key-value pairs to the one or more machine learning models.

5. The method of claim 1, wherein generating the multiple actions comprises generating the multiple actions using a scenario-based dynamic path generation process to identify feasible actions by a user after an event based on current context, historical data, and previous interactions stored in a user knowledge database.

6. The method of claim 1, wherein identifying the one or more selectable actions comprises:
assigning a likelihood score to each of the multiple actions based on the data inputs and the context information; and
identifying which of the multiple actions has a likelihood score exceeding a specified threshold based on user preferences stored in a user knowledge database.

7. The method of claim 1, wherein:
identifying the one or more selectable actions comprises identifying action paths of the multiple actions based on device functionality and generating executable function calls for the action paths; and
generating the one or more actionable task recommendations comprises using a ranker model to prioritize the action paths based on at least one of: one or more past user interactions, context relevancy, or one or more user preferences determined from a user knowledge database.

8. An electronic device comprising:
at least one processing device configured to:
obtain data inputs and context information;
proactively generate multiple actions using one or more machine learning models;
obtain reference data relevant to the data inputs and the context information;
verify the multiple actions using the reference data;
identify one or more selectable actions from the multiple actions;
generate one or more actionable task recommendations based on the one or more selectable actions; and
initiate presentation of the one or more actionable task recommendations on a display.

9. The electronic device of claim 8, wherein, to obtain the reference data, the at least one processing device is configured to:
collect, using a learning engine, user knowledge data from at least one of: user profile data, a user knowledge graph, a user knowledge summary, user activities, app data, or data reasoning prompts; and
create the reference data based on the user knowledge data and a data grounding service.

10. The electronic device of claim 9, wherein the data grounding service is configured to correlate textual or unstructured data with entities and relationships represented in the user knowledge graph.

11. The electronic device of claim 8, wherein the at least one processing device is further configured to:
format the data inputs and the context information into key-value pairs; and
provide the key-value pairs to the one or more machine learning models.

12. The electronic device of claim 8, wherein the at least one processing device is configured to generate the multiple actions using a scenario-based dynamic path generation process to identify feasible actions by a user after an event based on current context, historical data, and previous interactions stored in a user knowledge database.

13. The electronic device of claim 8, wherein, to identify the one or more selectable actions, the at least one processing device is configured to:
assign a likelihood score to each of the multiple actions based on the data inputs and the context information; and
identify which of the multiple actions has a likelihood score exceeding a specified threshold based on user preferences stored in a user knowledge database.

14. The electronic device of claim 8, wherein:
to identify the one or more selectable actions, the at least one processing device is configured to identify action paths of the multiple actions based on device functionality and generating executable function calls for the action paths; and
to generate the one or more actionable task recommendations, the at least one processing device is configured to use a ranker model to prioritize the action paths based on at least one of: one or more past user interactions, context relevancy, or one or more user preferences determined from a user knowledge database.

15. A non-transitory machine-readable medium containing instructions that when executed cause at least one processor of an electronic device to:
proactively generate multiple actions using one or more machine learning models;
verify the multiple actions using reference data based on data inputs and context information;
identify one or more selectable actions from the multiple actions;
generate one or more actionable task recommendations based on the one or more selectable actions; and
initiate presentation of the one or more actionable task recommendations on a display.

16. The non-transitory machine-readable medium of claim 15, wherein the instructions that when executed cause the at least one processor to obtain the reference data comprise instructions that when executed cause the at least one processor to:
collect, using a learning engine, user knowledge data from at least one of: user profile data, a user knowledge graph, a user knowledge summary, user activities, app data, or data reasoning prompts; and
create the reference data based on the user knowledge data and a data grounding service.

17. The non-transitory machine-readable medium of claim 16, wherein the data grounding service is configured to correlate textual or unstructured data with entities and relationships represented in the user knowledge graph.

18. The non-transitory machine-readable medium of claim 15, further containing instructions that when executed cause the at least one processor to:
format the data inputs and the context information into key-value pairs; and
provide the key-value pairs to the one or more machine learning models.

19. The non-transitory machine-readable medium of claim 15, wherein the instructions that when executed cause the at least one processor to generate the multiple actions comprise:
instructions that when executed cause the at least one processor to generate the multiple actions using a scenario-based dynamic path generation process to identify feasible actions by a user after an event based on current context, historical data, and previous interactions stored in a user knowledge database.

20. The non-transitory machine-readable medium of claim 15, wherein the instructions that when executed cause the at least one processor to identify the one or more selectable actions comprise instructions that when executed cause the at least one processor to:
assign a likelihood score to each of the multiple actions based on the data inputs and the context information; and
identify which of the multiple actions has a likelihood score exceeding a specified threshold based on user preferences stored in a user knowledge database.
